(19) United States
(12) Patent Application Publication
(10) Pub. No.: US 2023/0141354 A1
(43) Pub. Date: May 11, 2023

(54) ENCAPSULATED PARTICLES

(71) Applicant: GOODWIN PLC, Stoke-On-Trent, Staffordshire (GB)

(72) Inventors: Calvin TAN, Stoke-On-Trent, Staffordshire (GB); Matthew Stanley GOODWIN, Stoke-On-Trent, Staffordshire (GB)

(21) Appl. No.: 17/997,912

(22) PCT Filed: May 6, 2021
(86) PCT No.: PCT/GB2021/051095

§ 371 Date: Nov. 3, 2022

(30) Foreign Application Priority Data
May 7, 2020 (GB) 2006775.7

(51) Int. Cl. C09C 3/06; C09C 1/62; C09C 1/64; C08K 9/02; C09J 11/04; B22F 1/05; B22F 1/16; B22F 1/065

(52) U.S. Cl. CPC C09C 3/063; C09C 1/627; C09C 1/642; C08K 9/02; C09J 11/04; B22F 1/05; B22F 1/16; B22F 1/065; C01P 2004/34; C01P 2004/80; C01P 2004/61; C01P 2006/32; C08K 2201/001; C08K 2201/005; B22F 2304/10; B22F 2302/256; B22F 2301/052; B22F 2301/10; B22F 2301/255; B22F 2301/35

(57) ABSTRACT

The invention relates to an encapsulated metal particle comprising a core encapsulated in a shell, wherein the core comprises a metallic substance, and wherein the shell comprises a insulating substance. The invention also relates to a polymer composition comprising a plurality of the encapsulated metal particles, a mixture comprising a plurality of encapsulated metal particles and plurality of polymer particles, and the use of the encapsulated metal particle as an additive for increasing the thermal conductivity and/or radio frequency (RF) conductivity of a matrix substance such as an adhesive.

### FIELD OF THE INVENTION

The present invention relates to encapsulated particles, a polymer composition comprising encapsulated particles, a mixture comprising encapsulated particles and a polymer, and the use of encapsulated particles as an additive for increasing the thermal conductivity and/or radio frequency (RF) conductivity of a matrix.

### BACKGROUND TO THE INVENTION

Polymers generally have electrical insulating properties, poor thermal conductivity, and poor radio frequency (RF) conductivity. Substances can be added to polymers to alter the properties, for example micronized graphite, PTFE, glass fibres, metallic particulates etc. can be added to alter the mechanical and thermal properties of polymers. However, filler materials added to improve the thermal conductivity of the material are generally inherently electrically conductive, such as graphite or powdered metal.

To-date there have been attempts to enhance the thermal conductivity of polymer substances whilst keeping the polymer an electrical insulator. Such attempts have included the addition of small diamond particulates into polymers. Diamonds are a different form of carbon to graphite; they are electrically insulating and have a high thermal conductivity so they can increase the thermal conductivity whilst keeping the polymer electrically insulating. However, the manufacturing cost associated with diamond fillers makes them prohibitively expensive. Similarly beryllium oxide, as a highly thermally conductive, electrically insulating additive can be used as a filler material in polymers. However this subsequently cannot be machined or processed easily as any dust is highly carcinogenic, and in the raw powder form prior to processing can cause chronic beryllium disease.

There therefore remains a need to find a safe, cost-effective way of improving the thermal conductivity and/or radio frequency (RF) conductivity of substances such as polymers, whilst keeping them electrically insulating.

### SUMMARY OF THE INVENTION

The present invention provides a cost effective additive that when incorporated into a polymer will substantially retain the inherent electrical insulating properties of the polymer, but also increase its thermal conductivity and provide radio frequency (RF) conductivity.

Thus, in a first aspect, the present invention provides a plurality of encapsulated metal particles, the particles comprising a core encapsulated in a shell, wherein the core is homogeneous and comprises a metallic substance, and wherein the shell is in direct contact with the core and comprises glass, wherein the encapsulated metal particles have a number median diameter (Dn50) of from 3 μm to 20 μm as determined by optical microscopy.

In a second aspect, the present invention provides a polymer composition comprising a plurality of the encapsulated metal particles of the first aspect.

In a third aspect, the present invention provides a mixture comprising a plurality of encapsulated metal particles of the first aspect and a plurality of polymer particles.

In a fourth aspect the present invention provides the use of a plurality of encapsulated metal particles of the first aspect as an additive for increasing the thermal conductivity and/or radio frequency (RF) conductivity of a matrix substance.

In one further aspect, the present invention provides an encapsulated metal particle comprising a core encapsulated in a shell, wherein the core comprises a metallic substance, and wherein the shell comprises an insulating substance.

In a second further aspect, the present invention provides a polymer composition comprising a plurality of the encapsulated metal particles of the further aspect.

In a third further aspect, the present invention provides a mixture comprising a plurality of encapsulated metal particles of the first further aspect and a plurality of polymer particles.

In a fourth further aspect the present invention provides the use of an encapsulated metal particle of the first further aspect as an additive for increasing the thermal conductivity and/or radio frequency (RF) conductivity of a matrix substance.

Without wishing to be bound by theory, it is believed that the encapsulated particles of the present invention are able to increase the thermal conductivity and/or RF conductivity of a substance by increasing its radiant conductivity and/or resonant conductivity. Radiant transfer is a harmonic or sympathetic energy transfer brought about across a distance by an electron oscillating in harmony to other electrons with a comparable harmonic frequency.

There are many different areas of technology in which is desirable to increase the ability of a substance to conduct heat and/or RF energy whilst remaining electrically insulating, and the present invention can therefore be used across a range of different applications, including but not limited to:
containment and/or heat extraction in high performance battery cells, increasing efficiency and longevity;
production of thin films for ultra-capacitors capable of resisting thermal shock more efficiently;
lightweight heatsinks that can be moulded rather than machined with applications in aerospace, extra planetary systems, high thermal output electrical systems, land and marine,
conductive components for energy harvesting/scavenging systems;
lightweight and mouldable microwave and UHF waveguides;
additive for adhesives providing for thermal equalisation across a bonded substrate (Stealth);
high performance polymer circuit boards or sensors that require thermally matched components; and
heat dissipation for transistors.

### BRIEF DESCRIPTION OF THE DRAWINGS

FIG. 1 is a cut-away representation of a substantially spherical encapsulated metal particle.

FIG. 2 is a cut-away representation of a faceted encapsulated metal particle.

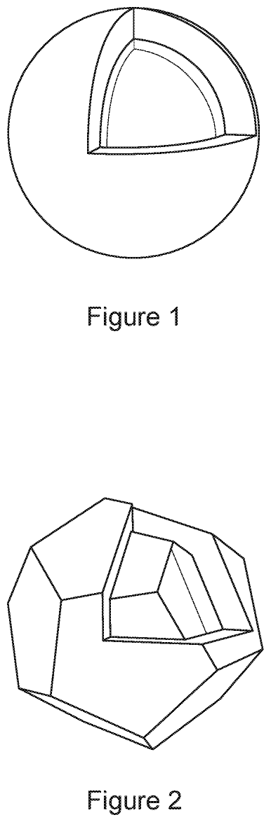

### DETAILED DESCRIPTION OF THE INVENTION

In a first aspect, the present invention provides a plurality of encapsulated metal particles, the particles comprising a core encapsulated in a shell, wherein the core is homogeneous and comprises a metallic substance, and wherein the shell is in direct contact with the core and comprises glass; wherein the encapsulated metal particles have a number median diameter (Dn50) of from 3 μm to 20 μm as determined by optical microscopy.

In a further aspect the present invention provides an encapsulated metal particle comprising a core encapsulated in a shell, wherein the core comprises a metallic substance, and wherein the shell comprises an insulating substance.

The insulating substance may be any substance which has electrically insulating properties. The insulating substance typically has a resistivity (Ωm at 20° C.) of 10⁴ or more (e.g. 10⁵ or more, 10⁶ or more, 10⁷ or more, 10⁸ or more, 10⁹ or more or 10¹⁰ or more)

The insulating substance may, for example, be a polymeric substance (e.g. a polyimide) or a ceramic substance. As used herein the term ceramic refers to a solid inorganic compound (e.g. an oxide, silicate, nitride or carbide) of a metal or metals, metalloid or non-metal and may be crystalline, amorphous (e.g. vitrified) or semi-crystalline.

The ceramic substance is typically a glass or a non-glass ceramic. The ceramic substance is preferably a glass. Glasses are amorphous, often transparent solids and examples include silicate glass (e.g. SiO₂), borosilicate glass, lead glass, and aluminosilicate glass.

The metallic substance may be an elemental metal, a metal alloy, or a combination of more than one metal. Typically, the metallic substance is an elemental metal or a metal alloy. Preferably, the metallic substance is silver, copper, gold, aluminium, iron, or an alloy thereof. As used herein, “an alloy thereof” refers to alloy of any of the stated metals with one or more further substances. More preferably, the metallic substance is silver or copper.

The core of the encapsulated metal particle comprises a metallic substance. The core typically comprises a single particle of the metallic substance or a plurality of particles of one or more metallic substance (e.g., an agglomeration of particles of the metal substance). Preferably, the core comprises a single particle of the metallic substance.

The core may further comprise a non-metallic substance in addition to the metallic substance. For example, the core may further comprise an inorganic non-metallic substance. The metallic substance is typically present in the core in an amount of 40 weight % or more (e.g. 50 weight % or more, 60 weight % or more, 70 weight % or more, 80 weight % or more, or 90 weight % or more).

Typically, the encapsulated metal particles have a particle size of from 0.1 to 1000 μm, e.g. 0.1 to 500 μm or 0.8 to 150 μm. More typically, the encapsulated metal particles have a particle size of from 3 μm to 20 μm. Preferably, the encapsulated metal particles have a particle size of from 0.8 to 150 μm, e.g. 0.8 μm to 110 μm, 0.8 to 75 μm, 0.8 to 110 μm, 3 to 75 μm, 6 μm to 60 μm, 6 μm to 35 μm, 10 μm to 30 μm or 10 μm to 20 μm. Encapsulated metal particles having a particle size of 0.8 to 75 μm are particularly preferred. Encapsulated particles having a size within these ranges may have improved radiant and/or resonant conductivity.

Encapsulated metal particles having a particle size of from 3 μm to 20 μm are associated with particularly beneficial properties. At particle sizes above 20 μm, a polymer matrix in which the particles are distributed may be at increased risk of fracture when exposed to high temperatures and/or RF radiation. At particle sizes below 3 μm, there may be a reduced effect on the thermal conductivity and/or RF conductivity of a matrix substance when the encapsulated particles are incorporated.

Within the range of 3 μm to 20 μm, the encapsulated metal particles may typically have a size of 4 μm or more, 5 μm or more, 6 μm or more, 7 μm or more, 8 μm or more, 9 μm or more, 10 μm or more, 11 μm or more, 12 μm or more, 13 μm or more, 14 μm or more, 15 μm or more, 16 μm or more, 17 μm or more, 18 μm or more, or 19 μm or more; and may typically have a size of 19 μm or less, 18 μm or less, 17 μm or less, 16 μm or less, 15 μm or less, 14 μm or less, 12 μm or less, 11 μm or less, 10 μm or less, 9 μm or less, 8 μm or less, 7 μm or less, 6 μm or less, 5 μm or less, or 4 μm or less. Combinations of the above mentioned typical lower and upper sizes are also envisaged.

The particle size of the encapsulated metal particle typically refers to the number median diameter (Dₙ₅₀) of a plurality of the encapsulated particles as determined by optical microscopy, for example according to the technique taught in Wills' Mineral Processing Technology by Barry A. Wills and James A. Finch (8^{th} Edition, 2016, § 4.4.4). For the avoidance of doubt, the particle sizes used herein refer to the size of the entire encapsulated particle (i.e. core and shell).

The encapsulated metal particle may be any shape, and may be regular or irregular. The encapsulated metal particle may for example have a substantially spherical (e.g. spherical or spheroid) shape, a faceted shape, a needle-like shape, a columnar shape or a mixture of shapes. As used herein, an encapsulated metal particle having a faceted shape typically has one or more substantially planar surfaces, the one or more substantially planar surfaces typically making up 20% or more (e.g. 30% or more, 50% or more, 60% or more, 70% or more, 80% or more, or 90% or more) of the total surface area of the particle. The encapsulated metal particle typically has a substantially spherical shape.

The encapsulated metal particle comprises the core and the shell described herein. In certain embodiments, the encapsulated metal particle consists essentially of the core and the shell described herein. In certain embodiments the encapsulated metal particle consists of the core and the shell described herein.

The core comprises the metallic substance described herein. In certain embodiments the core consists essentially of the metallic substance described herein. In certain embodiments the core consists of the metallic substance described herein. The shell comprises the insulating substance described herein (e.g. the ceramic substance described herein). In certain embodiments the shell consists essentially of the insulating substance described herein (e.g. the ceramic substance described herein). In certain embodiments the shell consists of the insulating substance described herein (e.g. the ceramic substance described herein).

In the plurality of encapsulated metal particles of the first aspect, the core is homogeneous and the shell is in direct contact with the core. Accordingly, in the plurality of encapsulated metal particles of the first aspect, there are no intermediate or spacer layers between the metallic core and the glass shell.

In a second aspect, the present invention provides a polymer composition comprising a plurality of the encapsulated metal particles of the first aspect.

In a second further aspect, the present invention provides a polymer composition comprising a plurality of the encapsulated metal particles of the further aspect.

In the polymer composition, the encapsulated metal particles are typically distributed in a polymer matrix.

The encapsulated metal particles are typically isotopically orientated in the polymer matrix. Thus, the distribution of the encapsulated metal particles in the polymer matrix is typically uniform in all orientations. Polymer compositions in which the encapsulated metal particles are isotopically orientated in the polymer matrix can be obtained e.g. by processing a mixture comprising polymer particles and encapsulated metal particles in the absence of an applied electrical field.

The thermal and/or RF conductivity of the composition is dependent, in part, on the amount of encapsulated metal particles present. The amount can therefore be selected according to the desired thermal and/or RF conductivity.

The encapsulated metal particles are typically present in the polymer composition in an amount of 5 wt % or more (e.g. 10 wt % or more, 15 wt % or more, or 20 wt % or more), based on the total weight of the polymer composition. The encapsulated metal particles are typically present in the polymer composition in an amount of 85 wt % or less, e.g. 65 wt % or less, 40 wt % or less, 35 wt % or less, 30 wt % or less, or 25 wt % or less), based on the total weight of the polymer composition. More typically, the encapsulated metal particles are present in an amount of from 5% to 85% by weight, (e.g. from 5% to 65% by weight, from 5% to 40% by weight, from 10% to 35% by weight, from 15% to 30% by weight, or from 20 to 25% by weight), based on the total weight of the polymer composition or mixture.

The polymer matrix may comprise any polymer for which it is desirable to increase the heat conductivity and/or RF conductivity. Examples include fluoropolymers, such as polytetrafluoroethylene (PTFE), perfluoroalkoxy alkanes (PFA), fluorinated ethylene propylene (FEP), polyvinylidene fluoride (PVDF), ethylene chlorotrifluoroethylene (ECTFE), polyimides such as poly(4,4′-oxydiphenylene-pyromellitimide), polyamides, and epoxy resins.

In a third aspect, the present invention provides a mixture comprising a plurality of encapsulated metal particles of the first aspect and a plurality of polymer particles.

In a third further aspect, the present invention provides a mixture comprising a plurality of encapsulated metal particles of the further aspect and a plurality of polymer particles.

The encapsulated metal particles are typically present in the polymer composition in the amounts described above with reference to the polymer composition of the second aspect. The encapsulated metal particles are typically present in the polymer mixture in the amounts described above with reference to the polymer composition of the second aspect.

The nature and identity of the polymer in the polymer particles of is typically as described above with reference to the polymer matrix of the polymer composition of the second aspect.

As well as being incorporated into polymer compositions and mixtures as described above with reference to the second and third aspects of the invention, the encapsulated metal particles can also be incorporated into adhesive substances. Accordingly, also disclosed herein is an adhesive comprising an adhesive substance and a plurality of the encapsulated metal particles of the first aspect.

The adhesive substance may be any adhesive for which it is desirable to increase the heat conductivity and/or RF conductivity. Examples include epoxy systems, sodium silicates, silicone, fluorosilicones, and cyanoacrylates. The adhesive may be capable of maintaining adhesive function at elevated temperatures (e.g. 100° C. or more, 150° C. or more, 200° C. or more or 250° C. or more).

In a fourth aspect the present invention provides the use of an encapsulated metal particle of the first aspect as an additive for increasing the thermal conductivity and/or radio frequency (RF) conductivity of a matrix substance.

In a fourth further aspect the present invention provides the use of an encapsulated metal particle of the further aspect as an additive for increasing the thermal conductivity and/or radio frequency (RF) conductivity of a matrix substance.

The use may comprise incorporating, or causing to be incorporated, a plurality of the encapsulated metal particles of the first aspect into the matrix substance. The plurality of the encapsulated metal particles may be incorporated, or caused to be incorporated, into the matrix in an amount as described above with reference to the polymer composition and polymer mixture of the second and third aspects of the invention.

In some embodiments of the use of the invention the matrix substance is a polymer, for example as described above with reference to the polymer composition and polymer mixture of the second and third aspects of the invention.

In the use of the invention the thermal and/or RF conductivity is typically increased by 50% or more (e.g. 100% or more, 200% or more, 300% or more, 400% or more, 500% or more, 1,000% or more, 10,000% or more, 100,000% or more, or 1,000,000% or more). Thermal conductivity can be measured by known techniques, for example by laser flash analysis. RF conductivity of a substance can be measured by time of flight (ToF), calculated as the ratio of the time an RF signal takes to pass through a sample of a substance with a specific thickness to the time the signal would take to travel through the equivalent distance in air.

The increase in thermal and/or RF conductivity achieved by the use of the present invention is typically measurable by comparing the thermal and/or RF conductivity of a matrix substance incorporating the encapsulated metal particles with the thermal and/or RF conductivity of the same matrix substance but which does not contain the encapsulated metal particles.

The encapsulated metal particles of the first aspect and the further aspect can be produced by providing a core comprising a metallic substance, and encapsulating the core in an insulating substance to form the shell. Encapsulation can be achieved by agitating particles of the metallic substance in a drum in the presence of a slurry of an insulating substance precursor (e.g. a slurry of a ceramic precursor substance), to coat the particles of the metallic substance in the slurry. The coated metallic particles are allowed to drop under gravity and the insulating substance may be formed from the insulating substance precursor. For example, metallic particles coated in a ceramic precursor substance may be heated so as to form a ceramic substance from the ceramic precursor substance. In some embodiments the coated metallic particles are heated by dropping through a plasma furnace. In embodiments where the ceramic substance is glass, the ceramic precursor substance may be a silicate slurry.

A plurality of encapsulated metal particles having a desired particle size (e.g. a desired number average median diameter; Dn50) can be obtained by techniques known to a skilled person. For example, prior to coating, the size of the core can be controlled by techniques known to a skilled person (e.g. milling and/or sieving and/or classification), and the size of the encapsulated metal particles can be controlled during formation by e.g. controlling the ratio of the insulating substance precursor to the core particles.

The polymer composition of the second aspect of the invention can be made by processing of the mixture of the third aspect. For example, the mixture of the third aspect can be heated to melt the plastic particles, followed by mixing to distribute the encapsulated metal particles, optionally shaping the molten mixture, and cooling to form the polymer composition. The polymer composition of the second aspect of the invention can alternatively be made by mixing encapsulated metal particles with a monomer or a monomer mixture, and by polymerising the monomer or monomer mixture with the encapsulated metal particles in situ.

The polymer composition of the second further aspect can be made by processing the mixture of the third further aspect, by analogy with the methods described above.

The mixture of the third aspect of the invention can be made by mixing encapsulated metal particles of the first aspect of the invention with polymer particles.

The mixture of the third further aspect of the invention can be made by mixing encapsulated metal particles of the further aspect of the invention with polymer particles.

The invention has been described with reference to certain embodiments. However, the present invention is not limited to the specific embodiments described herein and encompasses other embodiments falling within the scope of the claims, with due account being taken of any element which is equivalent to an element specified in the claims. Further, it is to be understood that features of the invention described above with reference to some embodiments/aspects of the invention can be combined with features which are described above with other embodiments/aspects of the invention.

1. A plurality of encapsulated metal particles, the particles comprising a core encapsulated in a shell, wherein the core is homogeneous and comprises a metallic substance, and wherein the shell is in direct contact with the core and comprises glass;
wherein the encapsulated metal particles have a number median diameter (Dn50) of from 3 μm to 20 μm as determined by optical microscopy.

2. A plurality of encapsulated metal particles according to claim 1, wherein the metallic substance is an elemental metal or a metal alloy.

3. A plurality of encapsulated metal particles according to claim 2, wherein the metallic substance is silver, copper, gold, aluminium, iron, or an alloy thereof.

4. A plurality of encapsulated metal particles according to any one of the preceding claims, wherein the core comprises a plurality of particles of the metallic substance.

5. A plurality of encapsulated metal particles according to any one of the preceding claims, wherein the core further comprises a non-metallic substance.

6. A plurality of encapsulated metal particles according to any one of claims 1 to 5, wherein the core is a single particle of the metallic substance.

7. A plurality of encapsulated metal particles according to any one of the preceding claims, having a substantially spherical shape or a faceted shape

8. A plurality of encapsulated metal particles according to claim 7, having a substantially spherical shape.

9. A polymer composition comprising a plurality of encapsulated metal particles as defined in any one of claims 1 to 8 distributed in a polymer matrix.

10. A polymer composition according to claim 9, wherein the encapsulated metal particles are isotropically orientated in the polymer matrix.

11. A mixture comprising a plurality of encapsulated metal particles as defined in any one of claims 1 to 8, and a plurality of polymer particles.

12. A polymer composition according to claim 9 or 10, or a mixture according to claim 12, wherein the encapsulated metal particles are present in an amount of from 5% to 85% by weight, based on the total weight of the polymer composition or mixture.

13. A polymer composition according to claim 9, 10 or 12, wherein the polymer matrix comprises a polymer which is a fluoropolymer, a polyimide, a polyamide, or an epoxy resin.

14. A polymer composition according to claim 13, wherein the polymer is selected from polytetrafluoroethylene, a perfluoroalkoxy alkane, fluorinated ethylene propylene, polyvinylidene fluoride, ethylene chlorotrifluoroethylene or poly(4,4′-oxydiphenylene-pyromellitimide).

15. A mixture according to claim 11 or 12, wherein the polymer particles comprise a polymer as defined in claim 13 or 14.

16. Use of a plurality of encapsulated metal particles as defined in any one of claims 1 to 8 as an additive for increasing the thermal conductivity and/or radio frequency (RF) conductivity of a matrix substance.

17. Use according to claim 16 wherein the matrix substance is a polymer.

18. Use according to claim 17 wherein the polymer is as defined in claim 13 or 14.

19. Use according to claim 18 wherein the matrix substance is an adhesive.

20. Use according to claim 19 wherein the matrix substance is an adhesive for which it is desirable to increase the heat conductivity and/or RF conductivity.

21. Use according to claim 19 or 20 wherein the adhesive is an epoxy system, a sodium silicate, silicone, a fluorosilicone, or a cyanoacrylate adhesive.

22. Use according to any one of claims 19 to 21 wherein the adhesive is capable of functioning as an adhesive at a temperature of 100° C. or more.

23. Use according to any one of claims 16 to 22, wherein the thermal conductivity and/or RF conductivity is increased by 50% or more.
